(19) United States
(12) Patent Application Publication
(10) Pub. No.: US 2023/0095622 A1
(43) Pub. Date: Mar. 30, 2023

(54) METHOD AND APPARATUS FOR ISOLATING AND LATCHING GPIO OUTPUT PADS

(71) Applicant: Advanced Micro Devices, Inc., Santa Clara, CA (US)

(72) Inventors: Alexander J. Branover, Boxborough, MA (US); Indrani Paul, Austin, TX (US); Benjamin Tsien, Santa Clara, CA (US); Christopher T. Weaver, Boxborough, MA (US); John P. Petry, San Diego, CA (US); Mihir Shaileshbhai Doctor, Santa Clara, CA (US); Thomas J. Gibney, Boxborough, MA (US)

(73) Assignee: Advanced Micro Devices, Inc., Santa Clara, CA (US)

(21) Appl. No.: 17/485,194

(22) Filed: Sep. 24, 2021

(51) Int. Cl. G06F 1/26; G06F 13/40

(52) U.S. Cl. CPC G06F 1/26; G06F 13/4068

(57) ABSTRACT

A method and apparatus for isolating and restoring general-purpose input/output (GPIO) pads in a computer system includes identifying GPIO pads associated with the region responsive to an entry into a power-down state of a region of a circuit. The GPIO pads are isolated from one or more external circuits. Upon exit from the power-down state, each associated GPIO pad is restored to a current value.

### BACKGROUND

During a power saving mode in a system on chip (SOC) computer system, as different power off modes are entered, various portions of the chip are shut down. As it will be necessary to wake these areas, it would be beneficial to maintain certain states in order to prevent losses from occurring. The sequence/order of different domains entering or exiting low power states is not predefined and is dependent on the state of the system.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2A is a block diagram of an example system in which one or more of the features of the disclosure can be implemented;

FIG. 2B is a block diagram of the example system of FIG. 2A shown in a partially powered down state;

FIG. 2C is a block diagram of the example system of FIG. 2A in a second powered down state; and

FIG. 3 is a flow diagram of an example method of isolating and latching GPIOs.

### DETAILED DESCRIPTION

Although the method and apparatus will be expanded upon in further detail below, briefly a method for isolating and latching general-purpose input/output (GPIO) pads in a computer system. When a system enters a power-down mode, it is desirable to be able to wake the system up in the same state it was in during the active state. For example, in a system on chip (SOC) computer system, in order to effect power savings, some areas associated with the SOC may be powered down for power savings. Although described in additional detail below, an SOC is a device where many components of an entire system are resident on a chip. For example, an SOC may include a processor, memory, storage, input and output drivers, and other components on a single chip.

A method for isolating and restoring general-purpose input/output (GPIO) pads in a computer system includes identifying GPIO pads associated with the region responsive to an entry into a power-down state of a region of a circuit. The GPIO pads are isolated from one or more external circuits. Upon exit from the power-down state, each associated GPIO pad is restored to a current value.

A system for isolating and restoring GPIO pads in a computer system includes a memory and a processor operatively coupled to and in communication with the memory. The processor is configured to: responsive to an entry into a power-down state of a region of a circuit, identify GPIO pads associated with the region, isolate the GPIO pads from one or more external circuits, and restore each associated GPIO pad to a current value upon exit from the power-down state.

A non-transitory computer-readable medium for isolating and restoring GPIO pads in a computer system, the non-transitory computer-readable medium having instructions recorded thereon, that when executed by the processor, cause the processor to perform operations. The operations include identifying GPIO pads associated with the region responsive to an entry into a power-down state of a region of a circuit. The GPIO pads are isolated from one or more external circuits. Upon exit from the power-down state, each associated GPIO pad is restored to a current value.

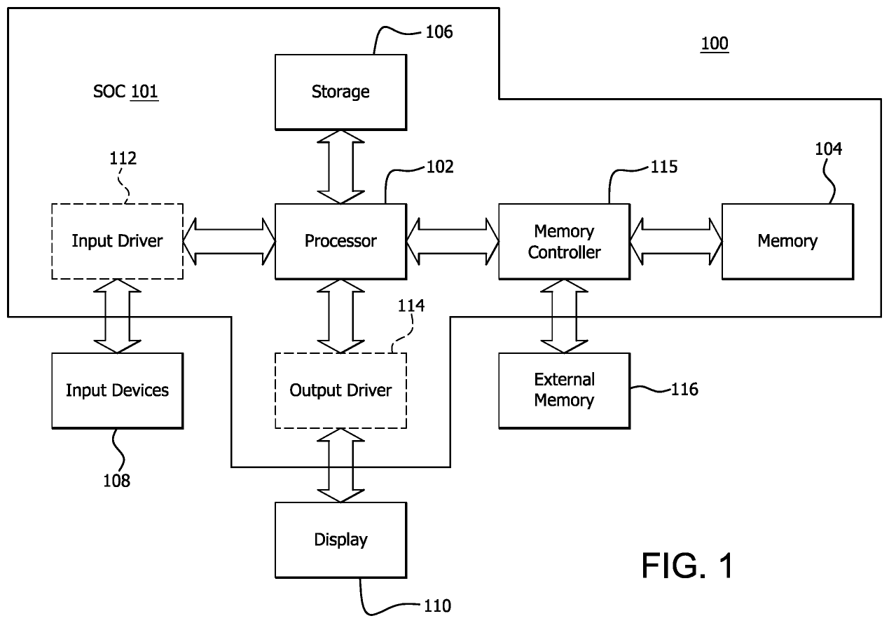

FIG. 1 is a block diagram of an example device 100 in which one or more features of the disclosure can be implemented. The device 100 can include, for example, a computer, a server, a gaming device, a handheld device, a set-top box, a television, a mobile phone, or a tablet computer. The device 100 includes a processor 102, a memory 104, a storage 106, one or more input devices 108, and one or more output devices 110. For purposes of example, the output device 110 is shown as being a display 110, however, it is understood that other output devices could be included.

The device 100 can also optionally include an input driver 112 and an output driver 114. Additionally, the device 100 includes a memory controller 115 that communicates with the processor 102 and the memory 104, and also can communicate with an external memory 116. In some embodiments, memory controller 115 will be included within processor 102 It is understood that the device 100 can include additional components not shown in FIG. 1.

As discussed above, the processor 102, memory 104, storage 106, input driver 112, output driver 114 and memory controller 115 may be included on an SOC 101.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

The external memory 116 may be similar to the memory 104, and may reside in the form of off-chip memory. Additionally, the external memory may be memory resident in a server where the memory controller 115 communicates over a network interface to access the external memory 116.

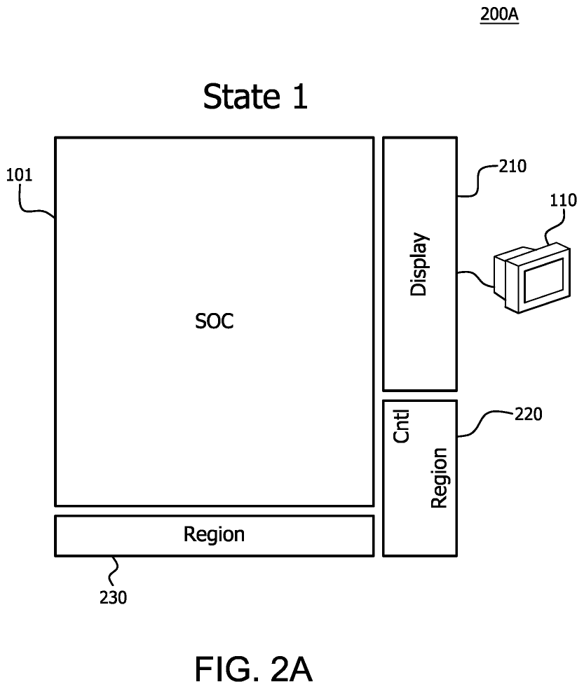

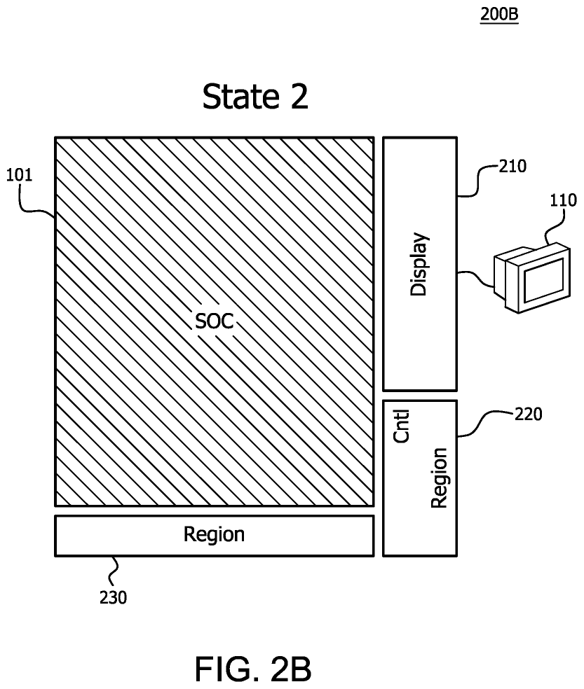

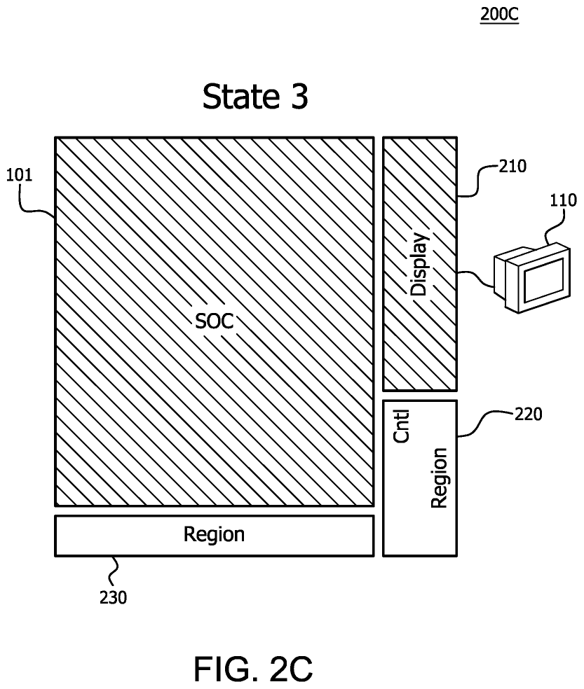

FIG. 2A is a block diagram of an example system 200A in which one or more of the features of the disclosure can be implemented. The example system 200A includes the SOC 101 that includes an associated display region circuitry 210 for controlling a display (e.g., display 110), an associated control region circuitry 220, and an associated additional region circuitry 230.

As mentioned above, the display region circuitry 210 is used to control a display (e.g., display 110). The display region circuitry may comprise any one or a combination of the following elements: firmware circuitry, processing circuitry configurable by software, or the like. The control region circuitry 220 is used for controlling additional devices that may be connected to the SOC 101, such as external memory devices (e.g., external memory 116). The control region circuitry 220 may also comprise any one or a combination of the following elements: firmware circuitry, processing circuitry configurable by software, or the like. The control region circuitry 220 may control devices relating to power management (e.g., power management controller), and circuitry responsible for external interfaces that are in communication with the SOC 101.

The additional region circuitry 230 is a region that controls additional devices that may be in communication with the SOC 101 (e.g., an external storage or optical drive). The additional region circuitry 230 may comprise any one or a combination of the following elements: firmware circuitry, processing circuitry configurable by software, or the like.

There is a benefit to powering down these different regions in the system. By powering down regions incrementally, it is possible to effect power savings by only operating and powering circuitry that is utilized in a particular power down state.

As shown in FIG. 2A, the system 200A is in a fully powered up state. In other words, the state is shown as State 1, which is effectively a fully powered state where all components of the system 200A are powered and operating prior to an entry into a powered down state. For example, in State 1, the SOC 101 the display region circuitry 210, the control region circuitry 220 and the additional region circuitry 230 are all powered on. In State 1, all of the associated components are all connected to the associated regions of circuitry. For example, display 110 is connected to a powered on display region circuitry 210. Accordingly, the GPIO pads associated with the circuitry regions 210, 220 and 230 are all powered on and operating.

FIG. 2B is a block diagram of the example system of FIG. 2A shown in a partially powered down state. In the state shown in FIG. 2B (i.e., State 2), the SOC 101 is in a power-down state. This means that the system 200B will utilize less power during this period. In this state, the display region circuitry 210 continues to operate, as well as the control region circuitry 220 and the additional region circuitry 230. In an example, an SOC power down may be triggered by a power controller associated with the SOC detecting an idle internal to the SOC and transitioning the SOC in the low power state.

When this idle occurs, the display 110 often remains powered on. This may happen, for example, where an idle is not long enough to cause a timer in the display to power the display off.

FIG. 2C is a block diagram of the example system of FIG. 2A shown in an additional partially powered down state. In the state shown in FIG. 2C (i.e., State 3), the SOC 101 and the display region circuitry 210 are powered down. This means that system 200C will utilize even less power than the system 200B of FIG. 2B.

Because of the power down in FIG. 2C, the GPIO pads associated with the display region circuitry 210 will be powered down and components connected to the display region circuitry 210 (e.g., display 110), will lose the connection with the circuitry. As such, the GPIO pad values

This state is a deeper power-down state than State 2. In State 2, the use of the display may not be required, but additional control processing may be required and therefore the control region may remain active and awake. Further, in additional power-down states, additional regions of the system may enter power-down, or power saving, states.

That is, in addition to the display region the control region may be powered down in yet a further and deeper state. On the wake up out of the additional power state described here, the control region may be powered up (e.g., to service an incoming interrupt) while the display region remains in the power down state.

Accordingly, in order to provide power savings, one or more regions of the circuitry described above in FIGS. 2A, 2B and 2C can be powered down depending on the amount of power savings and the required processing for actively running programs. It should be understood that any one or a combination of regions can be powered down depending on the amount of power savings required by the system.

As discussed above, each region of the circuitry described includes GPIO pads that are connected to an associated component. In some cases, those components may remain active during the various power down states. As described above, for example, in State 2, the display region circuitry 210 is powered down while the control region circuitry 220 remains active.

If the GPIO pad values for each pin are lost, errors may occur in those components that remain active. That is, each GPIO pad includes a value (e.g., 1 or 0) depending on the state of that pad and the component it is connected to. Once the area of circuitry is powered down (e.g., display region circuitry 210), the values of those pads will be lost unless they are preserved. Additionally, the components connected to those GPIO pads may or may not be powered off. That is, some components may continue to be utilized by being connected to other regions of the circuitry.

GPIO pads are utilized as processor in/out pins or as Advanced Configuration and Power Interface (ACPI) configurable functions that transfer information for higher levels of software. Knowledge of the values (i.e., 1 or 0) of each GPIO pad is therefore necessary to maintain uninterrupted operation if an area of circuitry the GPIO pad is resident is powered down.

Accordingly, as each power down state is entered, it is desirable to isolate and save the states of the GPIO pads of regions that are being powered down. In such a manner, when the regions exit the power-down state, the GPIO pads can be restored quickly to their settings avoiding data and latency losses. That is, the memory controller 115 may track the state of each GPIO pad and store it in a cache or memory for retrieval during a power up phase of each region of circuitry.

The preservation can occur in the form of saving the values of each GPIO in an on die or off-die memory to restore during the exiting of the power-down state. In the other embodiments the GPIO state can be retained on retention cells or in the always powered on SOC region. The savings of the GPIO pad states (values) can be performed by the memory controller 115, or any controller that may be provided access to the GPIO pad values.

On the entry into each progressively lower power state, where the SOC state is lost, it is therefore important, as described above, to preserve the GPIO pad values at each power state entry. That is, upon an entry into a first power savings state where a first region of circuitry is powered down, GPIO pads associated with that region will also be powered down and their values lost.

In general, power down states are incrementally entered. That is, a first power down state (e.g., State 2 in FIG. 2B) powers down a first region of circuitry will maintaining power to other regions. A second power down state (e.g., State 3 in FIG. 2C) powers down a second region of circuitry in addition to the first region of circuitry to effect additional power savings. Each power down state powers down additional circuitry for additional power savings.

As described above, entry into the second power savings state (e.g., State 2) powers down a second region of circuitry in addition to the first region of circuitry and the GPIO pads associated with that region will be powered down and their additional values lost along with the values of the GPIO pins associated with the first region.

Accordingly, at each level of power down, the GPIO pad values need to be unchanged to properly restore GPIO functionality on the exit from that low power state. That is, the GPIO pad values in the first power down state are needed in order to ensure that GPIO functionality is kept upon exit from the first power down state and the GPIO pad values in the second power down state are needed in order to ensure that GPIO functionality is kept upon exit from the second power down state.

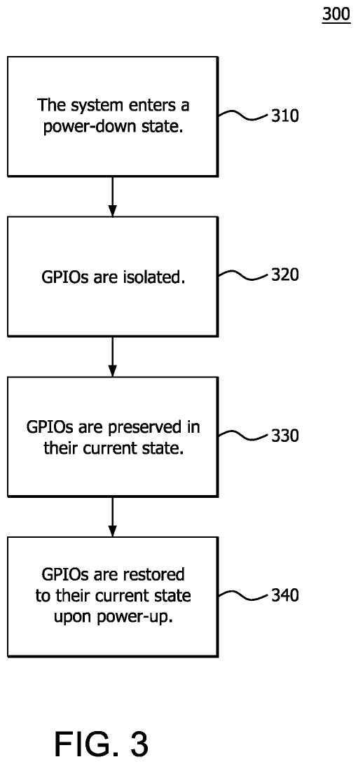

FIG. 3 is a flow diagram of an example method 300 of isolating and latching GPIO pins. Generally, an example technique for performing the method 300 above may include generating an isolation enable pulse, which could also be a level signal. This signal is sent to latch the GPIO pad to its current value. Once power is to be restored, the firmware (e.g., on-die sequencer) ensures that on exit the GPIOs are ready to be forced/restored into their previous values, which were the values they were latched to, and which are known to external devices and clients of those devices/components as their current values. The values could be latched by a smart multiplexer, latched internally, or stored in on-die or off-die memory.

As described herein, upon differing regions entering a power-down mode, the GPIO pads are identified and isolated for restoration. As each deeper state of power-down mode is entered, additional regions are identified and the GPIO pads for those regions are isolated and saved or latched for restoration. For example, as the display region circuitry 210 is powered down, the GPIO pad values for that region are latched for restoration. As such, upon powering up, any components associated with that circuitry area will encounter values expected on those GPIO pads.

By performing the power-down in this manner, power savings can be achieved, while also limiting glitches and other issues associated with GPIO pads not being isolated. Further, without knowing the states of the GPIO pads that are isolated, upon exiting from the power-down state, it is difficult to restore operation in a seamless manner. Additionally, if the platform component that the GPIO is connected to is also powered down, the GPIO output value can be powered off/de-asserted as well that is associated with that component.

In step 310, for example, the system enters a power-down state. This may include, for example, the system 200 of FIG. 2 powering down the SOC 102. Also, it may include a further power-down state where additional regions are powered down. That is, it may include a second, and deeper power-down state where in addition to the SOC 102, additional regions such as the display region 210 or control region 220 are powered down.

The GPIO pins (GPIOs) are then isolated so as to not have any power changes affect their settings (step 320). This is to make sure that no bad states associated with the loss of power are propagated to compromise the circuitry outside the platform (e.g., system 200). Further, the GPIOs are preserved in their current state (step 330). This is to ensure that upon exiting the power-down state, the settings of the GPIOs can be restored as well as other system clients perceiving the GPIOs being in the state they currently are.

The GPIO output value for each pad remains unchanged throughout the low power state (e.g., power down state the associated circuit to the GPIO pins are in). This is particularly important if platform components that the GPIO pins are connected to remain active while the processor circuitry is in one of the low power states.

As described above, the preservation can occur in the form of saving the values of each GPIO in an on die or off-die memory to restore during the exiting of the power-down state. In the other embodiments the GPIO state can be retained on retention cells or in the always powered on SOC region.

Upon power-up, the GPIO pad states are restored to their current state prior to the power-down (step 340), for example by the memory controller 115. That is, the saved states of the GPIOs are restored from where they are saved and the GPIOs pad values are set back to those states prior to power-up. In this manner, outside components that have client applications executing who were unaware of the power-down state will seamlessly perceive the GPIO states as they were previously. This is because when the regions associated with the GPIO pads are powered back up, the values of each pad will reflect the same value as prior to the power down. In this respect, the component connected to the GPIO pad will register the same value as it previously held. This prevents glitches on the GPIO pads that may lead to hazardous events in the system where a component is provided with an unexpected value on a GPIO pad.

For example, the GPIO may receive a trigger to initiate exit from the low power state. In this regard, the GPIO's wake up function needs to be duplicated in the Always On/Retention domain, which is an area of circuitry that is kept powered up during powering down of various regions. Once the power is restored, the GPIO state is copied in the GPIO logic, which is an area within the memory controller for example that operates and controls the GPIO pads to change a state of the GPIO pads.

So as each power down state is powered back up, the GPIO pad values associated with the circuitry for those powered down states needs to be duplicated and restored to the value it was prior to being powered down in order to avoid errors occurring. This is done by the memory controller, for example, setting the value of each GPIO pad to its previous value after accessing the value of that GPIO pad from the area of memory or cache that it was stored prior to powering down. As indicated above, the values are accessed by the memory controller, for example, when transitioning between the power states.

As mentioned previously, in summary, an example technique for performing the method 300 above may include generating an isolation enable pulse, which could also be a level signal. This signal is sent to latch the GPIO pad to its current value before powering down. Once power is to be restored, the firmware (e.g., on-die sequencer) ensures that on exit the GPIOs are ready to be forced/restored into their previous values, which are known to external devices and clients as their current values. The values could be latched by a smart multiplexer, latched internally, or stored in on-die or off-die memory.

As described above, upon differing regions entering a power-down mode, the GPIO pads are identified and isolated for restoration. As each deeper state of power-down mode is entered, additional regions are identified and the GPIO pads for those regions are isolated and saved or latched for restoration.

By performing the power-down in this manner, power savings can be achieved, while also limiting glitches and other issues associated with GPIO pads not being isolated. Further, without knowing the states of the GPIO pads that are isolated, upon exiting from the power-down state, it is difficult to restore operation in a seamless manner. Additionally, if the platform component that the GPIO is connected to is also powered down, the GPIO output value can be powered off/de-asserted as well that is associated with that component.

The methods provided can be implemented in a general-purpose computer, a processor, or a processor core. Suitable processors include, by way of example, a general purpose processor, a purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure. Further, although the methods and apparatus described above are described in the context of controlling and configuring PCIe links and ports, the methods and apparatus may be utilized in any interconnect protocol where link width is negotiated.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). For example, the methods described above may be implemented in the processor 102 or on any other processor in the computer system 100.

What is claimed is:

1. A method for isolating and restoring general-purpose/output (GPIO) pads, comprising:
responsive to an entry into a power-down state of a region of a circuit, identifying GPIO pads associated with the region;
isolating the GPIO pads from one or more external circuits; and
restoring each associated GPIO pad to a current value upon exit from the power-down state.

2. The method of claim 1, further comprising saving the states of the isolated GPIO pads.

3. The method of claim 2 wherein the states of the isolated GPIO pads are stored in an on-die memory.

4. The method of claim 2 wherein the states of the isolated GPIO pads are stored in an off-die memory.

5. The method of claim 1, further comprising latching the state of each associated GPIO pad to a current value.

6. The method of claim 5 wherein upon restoring, the latched GPIO pad is forced to its current state.

7. The method of claim 1, further comprising saving the GPIO state of each GPIO pad in a powered-on memory of a system on chip (SOC).

8. The method of claim 1 wherein the power-down state of the region of the circuit includes a first power-down state that powers down a first region of the circuit.

9. The method of claim 8 wherein the power-down state of the region of the circuit includes a second power-down state that powers down a second region of the circuit.

10. The method of claim 9 wherein the first region is a system on chip (SOC) region and the second region is a display region.

11. A system for isolating and restoring general-purpose input/output (GPIO) pads, comprising:
a memory; and
a processor operatively coupled to and in communication with the memory, the processor configured to:
responsive to an entry into a power-down state of a region of a circuit, identify GPIO pads associated with the region;
isolate the GPIO pads from one or more external circuits; and
restore each associated GPIO pad to a current value upon exit from the power-down state.

12. The system of claim 11, further comprising the processor saving the states of the isolated GPIO pads.

13. The system of claim 12 wherein the states of the isolated GPIO pads are stored in an on-die memory.

14. The system of claim 12 wherein the states of the isolated GPIO pads are stored in an off-die memory.

15. The system of claim 11, further comprising the processor latching the state of each associated GPIO pad to a current value.

16. The system of claim 15 wherein upon restoring, the latched GPIO pad is forced to its current state.

17. The system of claim 11, further comprising the processor saving the GPIO state of each GPIO pad in a powered-on memory of a system on chip (SOC).

18. The system of claim 11 wherein the power-down state of the region of the circuit includes a first power-down state that powers down a first region of the circuit.

19. The system of claim 18 wherein the power-down state of the region of the circuit includes a second power-down state that powers down a second region of the circuit.

20. A non-transitory computer-readable medium for isolating and restoring general-purpose input/output (GPIO) pads in a computer system, the non-transitory computer-readable medium having instructions recorded thereon, that when executed by the processor, cause the processor to perform operations including:
responsive to an entry into a power-down state of a region of a circuit, identifying GPIO pads associated with the region;
isolating the GPIO pads from one or more external circuits; and
restoring each associated GPIO pad to a current value upon exit from the power-down state.
